(19) United States
(12) Patent Application Publication
(10) Pub. No.: US 2018/0245220 A1
(43) Pub. Date: Aug. 30, 2018

(54) Enamelled Steel Sheet or Part and Process

(71) Applicant: ArcelorMittal, Luxembourg (LU)

(72) Inventors: Lode Duprez, Lokeren (BE); Philippe Gousselot, Metz (FR); Marc Leveaux, Marcq En Baroeul (FR); Javier Jimenez Gonzalez, Salinas Asturias (ES)

(21) Appl. No.: 15/968,356

(22) Filed: May 1, 2018

Related U.S. Application Data
(63) Continuation of application No. 12/747,105, filed on Nov. 8, 2010, now abandoned.

(30) Foreign Application Priority Data
Dec. 13, 2007 (EP) 07291521.8

(51) Int. Cl. C23D 3/00; B05D 7/14

(52) U.S. Cl. CPC C23D 3/00; B05D 7/14; Y10T 29/49982; Y10T 428/273; Y10T 428/252

(57) ABSTRACT

The present invention provides a steel sheet or part suitable for enamelling. The steel sheet or part is coated with a coating including polymer in which particles of non-oxide ceramic are homogeneously dispersed. A process for producing an enamelled steel sheet or part which has a reduced firing temperature and reduced time compared with conventional firing temperatures and times is also provided. An enamelled steel sheet or part are also provided.

The present invention relates to a steel sheet or part whose composition is suitable for enamelling, and which is coated on one or both sides with a coating consisting of a matrix of polymer in which particles of non-oxide ceramic are homogeneously dispersed, and the use of this coated steel sheet or part for producing an enamelled steel sheet or part.

It also relates to a process for manufacturing a steel sheet or part coated with a layer of ground coat enamel and an optional further layer of white or light-coloured cover coat enamel having a high adhesion with respect to the steel.

The protection of metallic surfaces by application of a layer of enamel is well-known, and is widely used due to its resistance to high temperature and because it gives the surface a protection against chemical aggression.

Enameled products are thus widely used in different applications such as in washing machines, sanitary ware, cooking range, domestic appliances, as well as outside construction materials.

The conventional process for producing enamelled steel sheet with a high adhesion between the steel sheet and the enamel coating, comprises the application to the steel sheet of a layer of enamel containing adherence promoting oxides such as cobalt, nickel, copper, iron, manganese, antimony or molybdenum oxides. This kind of enamel is called “ground coat enamel”.

The adhesion of the ground coat enamel on steel is obtained, by firing from 780 to 860° C. during 3 to 8 min, via oxido-reduction chemical reaction between the elements of the steel, such as carbon, and adherence promoting oxides of the ground coat enamel.

However, the time and temperature required to fire the enamel do not match anymore with nowadays industrial requirements.

The purpose of the present invention is therefore to remedy the aforementioned drawbacks and to provide a process for producing an enamelled steel sheet or part, which allows a decrease of the consumption of energy by decreasing the firing temperature by 10 to 40° C. compared with conventional firing temperatures, and an increase of the productivity by decreasing the firing time by 1 to 3 min compared with conventional firing times, while maintaining both a good adhesion and surface aspect of the enamel layer.

The object of the invention is therefore a process for enamelling a steel sheet or part comprising the steps consisting in:
applying to one or both sides of a steel sheet whose composition is suitable for enamelling, a formulation layer comprising 0.008 to 5% by weight of particles of non-oxide ceramic whose melting point is above 600° C., an optional solvent, the balance being a polymer which, when heated from ambient temperature to 800° C. in air, gets burned at more than 80% by weight at 440° C. and is completely burned at 600° C.,
curing said layer so as to obtain a polymer coating in which the particles of non-oxide ceramic are homogeneously dispersed,
optionally subjecting said coated steel sheet to a forming operation in order to obtain a part,
applying to said polymer coating a layer of ground coat enamel, and optionally a further layer of white or light-coloured cover coat enamel, then
subjecting said ground coat enamel and said optionally white or light-coloured cover coat enamel to a firing to obtain an enamelled steel sheet or part.

The process according to the invention is advantageous not only because a decrease of the firing temperature and time is achieved, but also because unfriendly environmental preparation of the steel sheet, before and after the application of the formulation, and before the enamelling, such as intensive pickling with acidic solutions and/or nickling, is not required.

A steel sheet or part whose composition is suitable for enamelling is defined according to the European standard EN 10209, and is characterized by a low-carbon content, generally less than 0.08% by weight, in order to avoid the formation of bubbles during the firing of the enamel. Thus, low carbon steel grade with a carbon content less than 0.08% by weight, ultra-low carbon steel grade with a carbon content less than 0.005% by weight and Ti-interstitial free steel with a carbon content less than 0.02% by weight may be considered to carry out the present invention.

A second object of the invention is a steel sheet or part coated on one or both sides with a coating consisting of a matrix of polymer in which particles of non-oxide ceramic are homogeneously dispersed, the coating weight of said particles being between 0.001 and 0.250 g/m², the melting point of said non-oxide ceramic being above 600° C., the composition of said steel sheet or part being suitable for enamelling, and said polymer, when heated from ambient temperature to 800° C. in air, getting burned at more than 80% by weight at 440° C. and being completely burned at 600° C.

Finally a third object of the invention is the use of said coated steel sheet or part for producing an enamelled steel sheet or part

After hot rolling and cold rolling, a steel sheet whose composition is suitable for enamelling, is simply degreased in order to remove all traces of lubricant, and is coated on one or both sides with a formulation layer comprising 0.008 to 5% by weight of particles of non-oxide ceramic whose melting point is above 600° C., an optional solvent, the balance being a polymer which, when heated from ambient temperature to 800° C. in air, gets burned at more than 80% by weight at 440° C. and is completely burned at 600° C.

The application of said formulation may be performed in a conventional manner, for example by dipping, roll coating, or spraying.

Then, said steel sheet coated with said formulation layer is cured so as to obtain a steel sheet coated with a polymer coating in which the particles of non-oxide ceramic are homogeneously dispersed.

Said polymer may be for example polyester, poly-acrylic, polyurethane, polyethylene, polypropylene, or the mixtures thereof.

In one embodiment of the invention, the polymer may be a radiation curable polymer, and the formulation is free of solvent.

The curing of said radiation curable polymer is thus performed by exposing the formulation layer to ionizing or actinic radiation.

The ionizing radiation may be electron beam, and the actinic radiation may be ultra-violet light.

In another embodiment of the invention, the polymer may be a thermal curable polymer. In this case, the formulation comprises a solvent. According to the invention, the solvent plays no active role during the formation of the polymer coating, and no structural element from the solvent is incorporated into the polymer.

The content of solvent and polymer in the formulation is selected to obtain a fluid formulation which may be easily applied to the steel sheet.

In addition, the solvent makes it easier to control the thickness of the coating. Indeed, a solvent-free formulation comprising a thermal curable polymer would be solid at ambient temperature, and should be applied to the steel sheet as liquid melted either by pre-heating and spraying it to the surface of said steel sheet, or by rubbing it against the pre-heated steel sheet. In these conditions, it would be difficult to have a homogeneous particle distribution and maintain a constant and thin thickness.

Thus, said formulation preferably comprises 0.008 to 5% by weight of said particles of non-oxide ceramic, 10 to 70% by weight of said thermally curable polymer, the balance of the composition being a solvent.

When the steel sheet is coated with said formulation layer, it is subjected to a heat treatment so as to cure the polymer, and completely evaporate the solvent.

The solvent has to be completely removed from the polymer coating, otherwise it will be difficult to avoid the dirtying of the coating surface, and the adhesion of the enamel with the steel sheet will be reduced or even prevented.

The heat treatment is performed by heating said steel sheet from ambient temperature to a temperature T1, and maintaining it at this temperature T1 for a time t1. It may be achieved by induction curing or by blowing hot air.

Preferably, the temperature T1 is between 50 and 220° C., and the time t1 between 5 s and 60 s. Above 220° C., the polymer may start to burn down before the application of the ground coat enamel, and there is a risk that the particles of non-oxide ceramic are not embedded anymore in the polymer, and are not homogeneously distributed on the surface of the steel sheet, leading to a smaller reduction of the firing time and temperature.

If the time t1 is above 60 s or if the temperature T1 is below 50° C., the process does not match with industrial requirements of productivity. However, if the time t1 is below 5 s, the drying and the curing of the layer will be insufficient.

The solvent may be an organic solvent, a hydro-organic solvent, or preferably water due to environmental purpose.

In both embodiments, a reduction of the firing time and temperature of the further enamel layer and an improved adhesion of the enamel to the entire surface of the steel sheet can only be reached if:
1) the amount of particles of non-oxide applied to the steel sheet is sufficient to react with the adherence promoting oxides of the ground coat enamel as will be seen later. Indeed, it is essential that the coating weight of said particles of non-oxide ceramic is more than 0.001 g/m². However, the coating weight is limited to 0.250 g/m², because the adhesion of the enamel is not improved anymore above 0.250 g/m², and the cost increases. More preferably, the coating weight of said particles of non-oxide ceramic is between 0.01 to 0.10 g/m².
2) the particles of non-oxide ceramic are homogeneously distributed on the surface of the steel sheet. The role of the polymer is to keep the particles of non-oxide ceramic homogeneously distributed on the steel surface, before the application of the enamel.

Preferably, the coating weight of the polymer coating, after heat treatment or exposure to ionizing or actinic radiation, is sufficient to provide the steel sheet with an effective temporary corrosion protection before the application of the ground coat enamel, but is low enough so that the polymer easily burns down during the firing of the enamel.

Thus, the coating weight of said polymer coating is preferably between 0.5 and 10.0 g/m², which corresponds to an amount of particles of non-oxide ceramic between 0.08 and 10% by weight. More preferably, the coating weight of the polymer is between 2.0 and 6.0 g/m².

Said formulation may also contain additives well known in the art to further enhance its properties: for example, surfactants to promote wetting of the surface of the steel sheet to be treated, antifoams, corrosion inhibitors, pigments or bactericides. All of these additives are generally used in relatively small amounts, usually less than 3% by weight with respect to the formulation.

After heat treatment or exposure to radiation, and before enamelling, the steel sheet can be subjected to a forming operation by stamping, drawing or bending, so as to obtain a part.

Preferably, the polymer coating is sufficiently lubricating to avoid the application of a further lubricant before the optional forming step. In this case, there is no need to degrease the polymer coated part before the application of the enamel.

However, if the polymer coating, itself, is not sufficiently lubricating, a lubricant can be added to the formulation in the range of 0.3 to 5% by weight with respect to the polymer. Below 0.3% by weight, the lubricating effect will not be sufficient to form the steel sheet without a prior lubricating operation by oiling for example, but above 5% by weight, there is a risk that the coating has a greasy appearance.

The lubricant may be for example a hydrocarbon wax, a vegetable wax such as carnauba wax, a mineral or synthetic oil, a vegetable or animal oil containing fatty acid esters, or fatty acid.

After heat treatment or exposure to radiation and the optional forming step, a layer of ground coat enamel is applied to the polymer coating, and is subjected to firing.

A ground coat enamel is a glass whose components are in the form of powder. Generally, it comprises 40 to 50% by weight of silica, 10 to 20% of boric oxide, 2 to 10% by weight of aluminium oxide, 0.5 to 4% by weight of transition metal oxides such as cobalt, nickel, iron, manganese, antimony and molybdenum oxides, the balance of the composition being alkaline oxides and alkaline-earth oxides. The transition metal oxides are called adherence promoting oxides, because they can be reduced by the elements of the steel such as carbon, and thus make the link between the steel sheet and the enamel.

The layer of ground coat enamel can be applied directly in powder form by dry electrostatic powdering, or in wet form after mixing with water, by spraying or dipping.

In the latter case, water is preferably completely evaporated before the firing step, by heating the layer of enamel from ambient temperature to a temperature T2, and maintaining it at this temperature T2 for a time t2.

The time t2 is preferably below 60 s to match with industrial requirements of productivity. That is the reason why the lower limit for the temperature T2 is preferably above 80° C. The time t2 is preferably above 5 s to insure a complete evaporation of water during the drying of the enamel. Otherwise, if the enamel layer is not completely dried before the firing, water will evaporate during the firing step, and the bonding of the enamel with the steel sheet will be impaired.

The temperature T2 is preferably limited to 120° C., to avoid bubble formation in the enamel layer during the evaporation of water, which would further impair the bonding of the enamel within the steel sheet.

The drying of the enamel in wet form may be performed by blowing hot air.

After the drying of the enamel in wet form, and before the firing of said dried enamel, the enamel may be cooled to ambient temperature. However, it is preferable to subject it to firing when it is still at said temperature T2 to save energy.

In both cases, before being fired, the layer of enamel is porous and contains generally 30 to 60% by volume of air.

The firing of the ground coat enamel comprises several steps, during which the steel sheet is subjected to heating either from ambient temperature or from the temperature T2.

Above 240° C., the polymer starts to burn down. That means that it is progressively degraded by the combination of heat and oxygen coming from air contained in the enamel layer, into carbon dioxide and water vapour which are released in the ambient atmosphere.

The inventors noticed that it is essential that more than 80% by weight of the polymer gets burned at 440° C., because if more than 20% by weight of polymer is not degraded before the enamel becomes a viscous liquid, there is a risk of adhesion problems of the enamel on the steel sheet, and of crater formation due to a huge release of gas bubbles during the firing of the enamel, leading to a bad surface aspect of the enamel coating.

At a temperature T3 which is conventionally between 450 and 600° C., the ground coat enamel starts to soften and becomes a viscous liquid. The enamel layer is thus progressively changed from a porous layer into a continuous film, leading to a reduction of gaseous exchange. That is the reason why, the polymer has to be completely burned at 600° C., so as to avoid crater formation in the enamel coating due to release of gas bubbles, and adhesion problems of the enamel.

Then, as the temperature continues to increase, the particles of non-oxide ceramic and carbon coming from the steel reduce the transition metal oxides which are the most thermodynamically unstable oxides of the enamel, and give the adhesion of the enamel to the steel surface. The action of carbon is thus reinforced by the particles of non-oxide ceramic, which have the ability to compensate for the missing carbon of some kinds of steel, either nearly absent if ultra-low carbon steel is considered, or strongly bonded to titanium if titanium interstitial free steel is considered. As will be shown in the further examples, it has been observed that the firing temperature and time could be significantly reduced compared to the prior art.

Finally, the enamelled steel sheet is solidified by cooling to ambient temperature.

A non-oxide ceramic is a refractory material composed of a metal which is combined with carbon, nitrogen, boron, silicon or sulphur.

According to the invention, the melting point of the non-oxide ceramic has to be above 600° C., and preferably above 700° C., because it is essential to preserve the reduction ability of the particles of non-oxide ceramic during the firing step of the ground coat enamel. Indeed, at said temperature T3, a non-oxide ceramic having a melting point below 600° C. would start to melt and be oxidised by air contained in the enamel layer, and would thus lose its ability to reduce the transition metal oxides.

The particles of non-oxide ceramic can thus be selected from the group consisting of nitrides, borides, silicides, sulphides, carbides, and the mixtures thereof, having a melting point above 600° C.

It can be for example, silicon nitride (Si₃N₄), boron nitride (BN), aluminium nitride (AlN), silicon carbide (SiC), boron carbide (B₄C), magnesium boride (MgB₂), titanium boride (TiB₂), zirconium boride (ZrB₂), molybdenum silicide (MoSi₂) or tungsten sulphide (WS₂).

The average diameter D50 of said particles of non-oxide ceramic is preferably between 0.01 and 3 μm, because when the average diameter D50 is more than 3 μm, the reactivity of the non-oxide ceramic towards transition metal oxides is not so high, and the reduction of firing time and temperature will be insufficient. On the other hand, below 0.01 μm, they are difficult to implement.

If a white or light-coloured surface aspect is required, a further layer of white or light-coloured cover coat enamel may be applied to the surface of the ground coat enamel. The firing of the layers of ground coat enamel and of white or light-coloured cover coat enamel can be performed either subsequently or simultaneously under the same conditions of firing temperature and time mentioned above.

The composition of white or light-coloured cover coat enamel is similar to that of ground coat enamel except that it comprises no transition metal oxides.

In the C.I.E. L.a.b. system adopted by CIE in 1976, a colour is represented by three numbers, which specify its position in a three-dimensional volume. The first number, the lightness L value, runs from 0 (black) to 100 (white), and defines how light or dark the colour is. The other numbers, a and b, give information about the colour from green to red, and from blue to yellow.

According to the invention, the lightness L of white or light coloured cover coat enamel is above 60.

After the firing, the thickness of the layer of ground coat enamel may be for example, between 80 and 150 μm if no further layer of white or light-coloured cover coat enamel is applied, and between 20 and 60 μm if a further layer of white or light-coloured cover coat enamel is applied, the thickness of said further layer being able to be between 80 and 120 μm.

The firing of the ground coat enamel, and of the further optional white or light-coloured cover coat enamel, may be performed in a conventional tunnel furnace having means for extracting fumes.

The invention will now be illustrated by examples given by way of non-limiting indication.

Trials were carried out using samples coming from a steel sheet suitable for enamelling, referenced as DC03ED according to the standard EN10209 (also known as Solfer®).

The aim is to compare the adhesion of samples which were enamelled according to the invention with samples which were conventionally enamelled.

### Production of Conventionally Enamelled Steel Sheets

After elimination of the protective oil from the surface of samples by conventional alkaline degreasing, a layer of conventional ground coat enamel referenced PP 12189, manufactured by Pemco International is applied to one side of a sample, in order to get an enamelled layer whose thickness is 110 μm after firing, that is about 400 g/m².

The enamelled samples are fired in a conventional furnace for enamelling at different firing temperatures and times, and the level of adhesion of the enamel layer is estimated according to the standard EN 10209, which defines a scale of five quotations, from 1 for an excellent adhesion to 5 for a bad adhesion. The results are shown in table I.

TABLE I

| | Firing temperature | | | | | |
|---|---|---|---|---|---|---|
| Firing time | (° C.) | | | | | |
| (min) | 800 | 810 | 820 | 830 | 840 | 860 |
| 2 | 5 | 4 | 4 | 3 | 2 | 1 |
| 2.5 | 4 | 3 | 3 | 2 | 1 | — |
| 3 | 4 | 3 | 3 | 2 | 1 | — |
| 3.5 | 3 | 2 | 2 | 1 | — | — |
| 4 | 3 | 2 | 1 | 1 | — | — |
| 4.5 | 2 | 2 | 1 | — | — | — |
| 5 | 1 | 1 | — | — | — | — |

(—): not tested

### Production of Steel Sheets Enamelled According to the Invention

Before enamelling, the samples are conventionally degreased by conventional alkaline solution in order to eliminate the protective oil from the surface.

Then, a layer of a formulation according to the invention is applied to one side of the samples.

Said formulation is prepared by mixing demineralised water, an aqueous acrylic polymer dispersion, referenced Prox AM355 from Protex-Synthron, and different kind of particles of non-oxide ceramic from H. C. Starck GmbH, as shown in table II. The content of water (including water coming from Prox AM355), acrylic polymer and non-oxide ceramic is expressed in % by weight with respect to the formulation.

TABLE II

| | Non-oxide ceramic | | | | | | | |
|---|---|---|---|---|---|---|---|---|
| | Si₃N₄ | TiB₂ | SiC | B₄C | BN | AlN | MoSi₂ | WS₂ |
| % of acrylic | 14.24 | 14.24 | 14.27 | 14.25 | 14.27 | 14.26 | 14.19 | 14.11 |
| polymer | | | | | | | | |
| % of ceramic | 0.33 | 0.33 | 0.11 | 0.26 | 0.11 | 0.18 | 0.64 | 1.2 |
| % of water | 85.43 | 85.43 | 85.62 | 85.49 | 85.62 | 85.56 | 85.17 | 84.69 |
| Total | 100 | 100 | 100 | 100 | 100 | 100 | 100 | 100 |

The formulation coating weight applied to the samples is 4 g/m², wet.

The formulation layer is cured and completely dried by heating it from ambient temperature to 90° C., and maintaining it at 90° C. for 30 s. When water is completely removed from the layer, the coating weight of the polymer coating is thus 0.6 g/m².

Then a layer of the same conventional ground coat enamel referenced PP 12189 previously used for producing conventional enamelled steel sheet, is applied to the polymer coating comprising the particles of non-oxide of ceramic. The application is performed in order to get an enamelled layer whose thickness is 110 μm after firing, that is about 400 g/m².

The enamelled samples according to the invention are fired in a conventional furnace for enamelling at different firing times and temperatures, and the level of adhesion of the enamel layer is estimated according to the standard EN 10209. The results are shown in table III.

The surface aspect of each sample enamelled according to the invention is visually checked by an operator, and compared with the surface aspect of the samples conventionally enamelled. No change is observed, the surface aspect is good for each sample enamelled according to the invention.

TABLE III

| Kind of | Time of | Temperature of firing | | | |
|---|---|---|---|---|---|
| ceramic | firing | (° C.) | | | |
| used | (min) | 800 | 810 | 820 | 830 |
| Si₃N₄ | 2 | — | — | 3 | — |
| | 2.5 | — | — | 2 | — |
| | 3 | — | 2 | 2 | — |
| | 3.5 | — | 2 | — | — |
| TiB₂ | 2 | — | — | 1 | — |
| | 2.5 | — | — | 1 | — |
| SiC | 2.5 | — | — | — | 1 |
| | 3 | — | 1 | — | — |
| B₄C | 2 | — | — | — | 1 |
| | 3 | — | — | 2 | — |
| | 3.5 | 2 | — | — | — |
| BN | 3 | — | — | 1 | — |
| | 3.5 | 1 | — | — | — |
| AlN | 2.5 | — | — | 2 | 1 |
| MoSi₂ | 3 | — | — | 1 | — |
| | 3.5 | 1 | — | — | — |
| WS₂ | 2.5 | — | — | 2 | — |
| | 3 | — | 2 | — | — |
| | 4 | 1 | — | — | — |

(—): not tested

From the comparison of tables I and III, it can be observed that the use of a non-oxide ceramic according to the invention allows a decrease of the firing temperature and time.

What is claimed is:

1. A steel sheet or part coated comprising:
a composition of said steel sheet or part being suitable for enamelling; and
a coating on at least one side of the steel sheet or part comprising a polymer in which particles of non-oxide ceramic are homogeneously dispersed, a coating weight of said non-oxide ceramic particles being between 0.001 and 0.250 g/m², a melting point of said non-oxide ceramic being above 600° C. and an average diameter D50 of said particles is between 0.01 and 3 μm;
said polymer, when heated from ambient temperature to 800° C. in air, is burned at more than 80% by weight at 440° C. and is completely burned at 600° C.

2. The steel sheet or part according to claim 1, wherein the coating weight of said particles of non-oxide ceramic is between 0.01 and 0.10 g/m².

3. The steel sheet or part according to claim 1, wherein the melting point of said non-oxide ceramic is above 700° C.

4. The steel sheet or part according to claim 1, wherein said particles of non-oxide ceramic are selected from the group consisting of nitrides, borides, silicides, sulphides, carbides and the mixtures thereof.

5. The steel sheet or part according to claim 4, wherein said nitride is boron, aluminium or silicon nitride.

6. The steel sheet or part according to claim 4, wherein said boride is magnesium, titanium or zirconium boride.

7. The steel sheet or part according to claim 4, wherein said silicide is molybdenum silicide.

8. The steel sheet or part according to claim 4, wherein said sulphide is tungsten sulphide.

9. The steel sheet or part according to claim 4, wherein said carbide is boron or silicon carbide.

10. The steel sheet or part according to claim 1, wherein the coating weight of said polymer coating is between 0.5 and 10.0 g/m².

11. The steel sheet or part according to claim 10, wherein the coating weight of said polymer is between 2.0 to 6.0 g/m².

12. The steel sheet or part according to claim 1, wherein the polymer is a polyester, poly-acrylic, polyurethane, polyethylene, polypropylene, or the mixtures thereof.

13. An enamelled steel sheet or part comprising:
the coated steel sheet or part according to claim 1.

14. A process for enamelling a steel sheet or part comprising the steps of:
applying to one or both sides of a steel sheet whose composition is suitable for enamelling, a formulation layer comprising 0.008 to 5% by weight of particles of non-oxide ceramic whose melting point is above 600° C., an optional solvent, the balance being a polymer which, when heated from ambient temperature to 800° C. in air, gets burned at more than 80% by weight at 440° C. and is completely burned at 600° C.;
curing said layer so as to obtain a polymer coating in which the particles of non-oxide ceramic are homogeneously dispersed;
optionally subjecting said coated steel sheet to a forming operation in order to obtain a part;
applying to said polymer coating a layer of ground coat enamel, and optionally a further layer of white or light-coloured cover coat enamel; then
subjecting said ground coat enamel and said optional white or light-coloured cover coat enamel to a firing to obtain an enamelled steel sheet or part.

15. The process according to claim 14, wherein, when the polymer is a radiation curable polymer, the formulation comprises no solvent.

16. The process according to claim 15, wherein said polymer is cured by exposure to ionizing or actinic radiation.

17. The process according to claim 16, wherein said ionizing radiation is electron beam.

18. The process according to claim 16, wherein said ionizing radiation is ultra-violet light.

19. The process according to claim 14, wherein the formulation comprises a solvent, and the polymer is a thermal curable polymer.

20. The process according to claim 19, wherein said formulation comprises 0.008 to 5% by weight of said particles of non-oxide ceramic, 10 to 70% by weight of said polymer, the balance of the formulation being a solvent.

21. The process according to claim 19, wherein said steel sheet coated with said formulation layer is subjected to a heat treatment by heating it from ambient temperature to a temperature T1 and maintaining it at said temperature T1 for a time t1, so as to completely evaporate the solvent and cure the polymer.

22. The process according to claim 21, wherein said temperature T1 is between 50 and 220° C., and said time t1 is between 5 and 60 s.
